(19) United States
(12) Patent Application Publication
(10) Pub. No.: US 2018/0024667 A1
(43) Pub. Date: Jan. 25, 2018

(54) HOVER-SENSITIVE TOUCHPAD

(71) Applicant: Tactual Labs Co., New York, NY (US)

(72) Inventor: Braon Moseley, Round Rock, TX (US)

(73) Assignee: Tactual Labs Co., New York, NY (US)

(21) Appl. No.: 15/224,266

(22) Filed: Jul. 29, 2016

Related U.S. Application Data
(60) Provisional application No. 62/365,881, filed on Jul. 22, 2016.

(51) Int. Cl. G06F 3/044

(52) U.S. Cl. CPC G06F 3/044; G06F 2203/04104; G06F 2203/04105; G06F 2203/04101

(57) ABSTRACT

Disclosed is a touch detector having a touch surface, a plurality of antennae positioned beneath the touch surface organized into logical rows and columns, the logical rows and columns being conductively connected via row and column traces to each other, and to signal emitters and signal receivers respectively. The antennae are spaced apart such that they do not touch one another. Signal emitters simultaneously output frequency-orthogonal signals that can be detected by signal processing the signal frames received from the receive antennae. A signal processor produces a heat map of touch proximate to the touch surface based at least in part on a measurement for each of the frequency-orthogonal signals from the frames.

This application is a non-provisional of U.S. Provisional Patent Application No. 62/365,881 filed Jul. 22, 2016, the entire disclosure of which is incorporated herein by reference.

### FIELD

The disclosed apparatus and methods relate in general to the field of user input, and in particular to input surfaces sensitive to touch, including, hover and pressure.

### BACKGROUND

Generally, a touchpad is a pointing device featuring a tactile sensor, a specialized surface that can translate the motion and position of a user's fingers to a relative position on the operating system that is outputted to the screen. Touchpads are commonly found on laptop computers, and may be used in place of a mouse for interacting with a desktop computer. Touchpads vary in size. Although most standalone touchpads are opaque, in recent years, the capacitive touch screens as found on tablets and phones are employed as touchpads.

Capacitive touch sensors have recently been coming into more widespread use in human-to-machine interfaces. Analog Devices, Inc., for example, provides integrated circuits (ICs) specifically designed for this purpose such as their parts AD7142 and AD7143. These ICs broadcast a high frequency excitation signal onto a common transmitter line, and use a plurality of capacitance inputs (14 inputs for the AD7142 or 8 inputs for the AD 7143) to detect changes in capacitance across the detector. Thresholds are used to determine touch.

Because known touchpads are designed to determine when a threshold is met, they generally cannot quickly and accurately identify a capacitive object (e.g., a finger) at a distance above the surface. Moreover, known touchpads cannot generally provide a heat map reflecting both a distance from the touch surface and the size, and shape of the one or more capacitive objects affecting the sensor.

These drawbacks are overcome, as disclosed herein, with a novel touchpad that can be used to quickly and accurately sense hover, contact and/or pressure information. Because of its speed and accuracy, the novel touchpad can acquire information concerning not only contact (or over-threshold data), but can also be used to determine the shape and position of the capacitive object, and thus, is useful in connection with augmented reality (AR) and virtual reality (VR) applications. For example, using the novel touchpad, a model of the user's hand and/or forearm may be created and displayed in a VR setting, enabling a user to operate a touchpad by virtual “sight,” essentially seeing what they are doing within the virtual world. Many other possibilities for the sensitive novel touchpad will be appreciated by a person of ordinary skill in the art in view of the disclosures herein.

### BRIEF DESCRIPTION OF THE DRAWINGS

The foregoing and other objects, features, and advantages of the disclosure will be apparent from the following more particular description of embodiments as illustrated in the accompanying drawings, in which reference characters refer to the same parts throughout the various views. The drawings are not necessarily to scale, emphasis instead being placed upon illustrating principles of the disclosed embodiments.

FIG. 1 shows a high level block diagram illustrating an embodiment of a low-latency touch sensor device.

FIG. 2A shows an isometric view of portions of a touchpad according to an embodiment described herein.

FIG. 2B shows a plan view of the portions of a touchpad shown in FIG. 2A.

FIG. 3A shows a plan view of another embodiment of a touchpad described herein.

FIG. 3B shows a plan view of a layer of the touchpad of FIG. 3A.

FIG. 3C shows a plan view of another layer of the touchpad of FIG. 3A.

FIG. 4 shows a plan view of a touchpad according to another embodiment described herein.

FIG. 5A shows a diagrammatic illustration of a cross section of a touchpad according to another embodiment described herein.

FIG. 5B shows a diagrammatic illustration of a cross section of a touchpad according to yet another embodiment described herein.

FIG. 5C shows a diagrammatic illustration of a cross section of a touchpad according to a further embodiment described herein.

FIG. 5D shows a diagrammatic illustration of a cross section of a touchpad according to yet a further embodiment described herein.

FIG. 5E shows a diagrammatic plan illustration of the antennae on one antennae layer of a touchpad according to an embodiment described herein.

FIG. 5F shows a diagrammatic plan illustration of the antennae on another antennae layer of a touchpad according to an embodiment described herein.

FIG. 6 shows a diagrammatic illustration of a cross section of a two-sided touchpad according to an embodiment described herein.

FIG. 7 shows a functional block diagram of an illustrative frequency division modulated touch detector.

### DETAILED DESCRIPTION

In various embodiments, the present disclosure is directed to touchpads and methods for designing, manufacturing and operating touchpads and touchpad sensors, and particular capacitive touchpad sensors. Although example compositions or geometries are disclosed for the purpose of illustrating the invention, other compositions and geometries will be apparent to a person of skill in the art in view of this disclosure without departing from the scope and spirit of the disclosure herein.

Throughout this disclosure, the terms “hover”, “touch”, “touches,” “contact,” “contacts” or other descriptors may be used to describe events or periods of time in which a user's finger, a stylus, an object or a body part is detected by the sensor. In some embodiments, these detections occur only when the user is in physical contact with a sensor, or a device in which it is embodied. In other embodiments, the sensor may be tuned to allow the detection of “touches” or “contacts” that are hovering a distance above the touch surface or otherwise separated from the touch sensitive device. As used herein, “touch surface” may not have actual features, and could be a generally feature-sparse surface. Therefore, the use of language within this description that implies reliance upon sensed physical contact should not be taken to mean that the techniques described apply only to those embodiments; indeed, nearly all, if not all, of what is described herein would apply equally to “touch” and “hover” sensors. More generally, as used herein, the term “touch” refers to an act that can be detected by the types of sensors disclosed herein, thus, as used herein the term “hover” is but one type of “touch” in the sense that “touch” is intended herein. Other types of sensors can be utilized in connection with the embodiments disclosed herein, including a camera, a proximity sensor, an optical sensor, a turn-rate sensor, a gyroscope, a magnetometer, a thermal sensor, a pressure sensor, a force sensor, a capacitive touch sensor, a power-management integrated circuit reading, a keyboard, a mouse, a motion sensor, and the like.

As used herein, and especially within the claims, ordinal terms such as first and second are not intended, in and of themselves, to imply sequence, time or uniqueness, but rather, are used to distinguish one claimed construct from another. In some uses where the context dictates, these terms may imply that the first and second are unique. For example, where an event occurs at a first time, and another event occurs at a second time, there is no intended implication that the first time occurs before the second time. However, where the further limitation that the second time is after the first time is presented in the claim, the context would require reading the first time and the second time to be unique times. Similarly, where the context so dictates or permits, ordinal terms are intended to be broadly construed so that the two identified claim constructs can be of the same characteristic or of different characteristic. Thus, for example, a first and a second frequency, absent further limitation, could be the same frequency—e.g., the first frequency being 10 Mhz and the second frequency being 10 Mhz; or could be different frequencies—e.g., the first frequency being 10 Mhz and the second frequency being 11 Mhz. Context may dictate otherwise, for example, where a first and a second frequency are further limited to being orthogonal to each other, in which case, they could not be the same frequency.

The presently disclosed systems and methods provide for designing, manufacturing and using touchpads and touchpad sensors, and particularly capacitive touchpad sensors that employ a multiplexing scheme based on orthogonal signaling such as but not limited to frequency-division multiplexing (FDM), code-division multiplexing (CDM), or a hybrid modulation technique that combines both FDM and CDM methods. References to frequency herein could also refer to other orthogonal signal bases. As such, this application incorporates by reference Applicants' prior U.S. patent application Ser. No. 13/841,436, filed on Mar. 15, 2013 entitled “Low-Latency Touch Sensitive Device” and U.S. patent application Ser. No. 14/069,609 filed on Nov. 1, 2013 entitled “Fast Multi-Touch Post Processing.” These applications contemplate capacitive FDM, CDM, or FDM/CDM hybrid touchpad sensors which may be used in connection with the presently disclosed sensors. In such sensors, touches are sensed when a signal from a row is coupled (increased) or decoupled (decreased) to a column and the result received on that column.

This disclosure will first describe the general operation of fast multi-touch sensors to which the present systems and methods for design, manufacturing and operation can be applied. Details of the presently disclosed system and method for the novel touchpad are then described further below under the heading “Illustration of Touchpad Embodiment.”

As used herein, the phrase “touch event” and the word “touch” when used as a noun include a near touch and a near touch event, or any other gesture that can be identified using a sensor. In accordance with an embodiment, touch events may be detected, processed and supplied to downstream computational processes with very low latency, e.g., on the order of ten milliseconds or less, or on the order of less than one millisecond.

In an embodiment, the disclosed fast multi-touch sensor utilizes a projected capacitive method that has been enhanced for high update rate and low latency measurements of touch events. The technique can use parallel hardware and higher frequency waveforms to gain the above advantages. Also disclosed are methods to make sensitive and robust measurements, which methods may be used on transparent display surfaces and which may permit economical manufacturing of products which employ the technique. In this regard, a “capacitive object” as used herein could be a finger, other part of the human body, a stylus, or any object to which the sensor is sensitive. The sensors and methods disclosed herein need not rely on capacitance. With respect to, e.g., the optical sensor, such embodiments utilize photon tunneling and leaking to sense a touch event, and a “capacitive object” as used herein includes any object, such as a stylus or finger, that that is compatible with such sensing. Similarly, “touch locations” and “touch sensitive device” as used herein do not require actual touching contact between a capacitive object and the disclosed sensor.

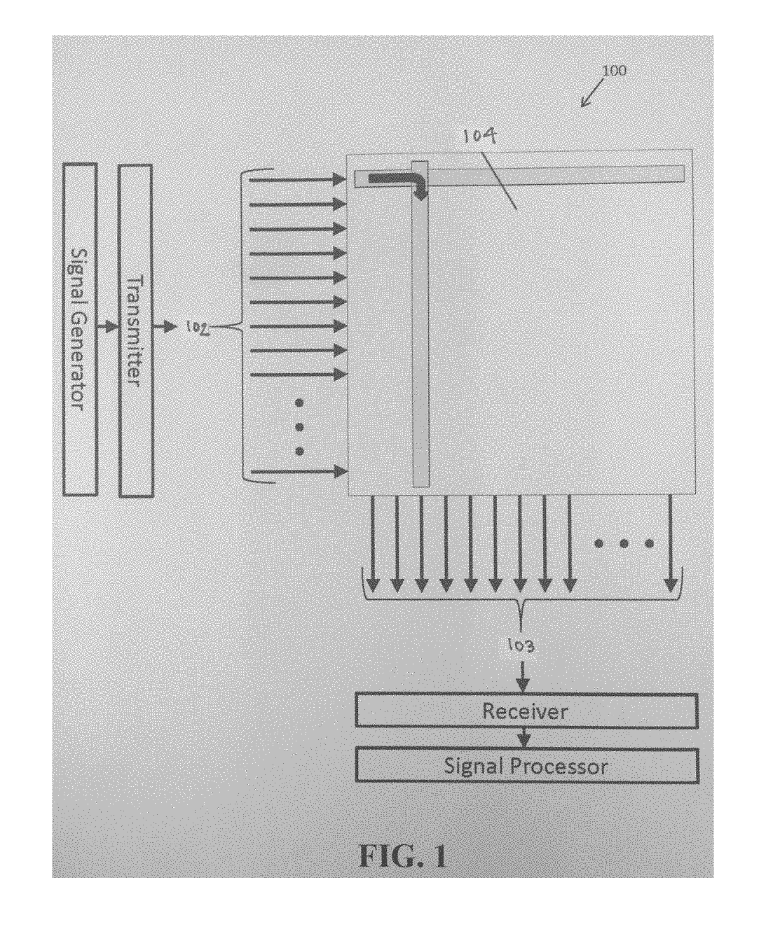

FIG. 1 illustrates certain principles of a fast multi-touch sensor 100 in accordance with an embodiment. At reference no. 102, a different signal is transmitted into each of the surface's rows. The signals are designed to be “orthogonal”, i.e., separable and distinguishable from each other. At reference no. 103, a receiver is attached to each column. The receiver is designed to receive any of the transmitted signals, or an arbitrary combination of them, with or without other signals and/or noise, and to individually determine a measure, e.g., a quantity for each of the orthogonal transmitted signals present on that column. The touch surface 104 of the sensor comprises a series of rows and columns (not all shown), along which the orthogonal signals can propagate. In an embodiment, the rows and columns are designed so that, when they are not subject to a touch event, a lower or negligible amount of signal is coupled between them, whereas, when they are subject to a touch event, a higher or non-negligible amount of signal is coupled between them. In an embodiment, the opposite could hold—having the lesser amount of signal represent a touch event, and the greater amount of signal represent a lack of touch. Because the touch sensor ultimately detects touch due to a change in the coupling, it is not of specific importance, except for reasons that may otherwise be apparent to a particular embodiment, whether the touch-related coupling causes an increase in amount of row signal present on the column or a decrease in the amount of row signal present on the column. As discussed above, the touch, or touch event does not require a physical touching, but rather an event that affects the level of coupled signal.

With continued reference to FIG. 1, in an embodiment, generally, the capacitive result of a touch event in the proximity of both a row and column may cause a non-negligible change in the amount of signal present on the row to be coupled to the column. More generally, touch events cause, and thus correspond to, the received signals on the columns. Because the signals on the rows are orthogonal, multiple row signals can be coupled to a column and distinguished by the receiver. Likewise, the signals on each row can be coupled to multiple columns. For each column coupled to a given row (and regardless of whether the coupling causes an increase or decrease in the row signal to be present on the column), the signals found on the column contain information that will indicate which rows are being touched simultaneously with that column. The quantity of each signal received is generally related to the amount of coupling between the column and the row carrying the corresponding signal, and thus, may indicate a distance of the touching object to the surface, an area of the surface covered by the touch and/or the pressure of the touch.

When a row and column are touched simultaneously, some of the signal that is present on the row is coupled into the corresponding column (the coupling may cause an increase or decrease of the row signal on the column). (As discussed above, the term touch or touched does not require actual physical contact, but rather, relative proximity.) Indeed, in various implementations of a touch device, physical contact with the rows and/or columns is unlikely as there may be a protective barrier between the rows and/or columns and the finger or other object of touch. Moreover, generally, the rows and columns themselves are not in touch with each other, but rather, placed in a proximity that allows an amount of signal to be coupled there-between, and that amount changes (positively or negatively) with touch. Generally, the row-column coupling results not from actual contact between them, nor by actual contact from the finger or other object of touch, but rather, by the capacitive effect of bringing the finger (or other object) into close proximity—which close proximity resulting in capacitive effect is referred to herein as touch.

The nature of the rows and columns is arbitrary and the particular orientation is irrelevant. Indeed, the terms row and column are not intended to refer to a square grid, but rather to a set of conductors upon which signal is transmitted (rows) and a set of conductors onto which signal may be coupled (columns). (The notion that signals are transmitted on rows and received on columns itself is arbitrary, and signals could as easily be transmitted on conductors arbitrarily designated columns and received on conductors arbitrarily named rows, or both could arbitrarily be named something else.) Further, it is not necessary that the rows and columns be in a grid. Other shapes are possible as long as a touch event will touch part of a “row” and part of a “column”, and cause some form of coupling. For example, the “rows” could be in concentric circles and the “columns” could be spokes radiating out from the center. And neither the “rows” nor the “columns” need to follow any geometric or spatial pattern, thus, for example, transmit and receive antennae could be arbitrarily connected to form rows and columns (related or unrelated to their relative positions.) Moreover, it is not necessary for there to be only two types signal propagation channels: instead of rows and columns, in an embodiment, channels “A”, “B” and “C” may be provided, where signals transmitted on “A” could be received on “B” and “C”, or, in an embodiment, signals transmitted on “A” and “B” could be received on “C”. It is also possible that the signal propagation channels can alternate function, sometimes supporting transmitters and sometimes supporting receivers. It is also contemplated that the signal propagation channels can simultaneously support transmitters and receivers—provided that the signals transmitted are orthogonal, and thus separable, from the signals received. Three or more types of antenna conductors may be used rather than just “rows” and “columns.” Many alternative embodiments are possible and will be apparent to a person of skill in the art after considering this disclosure.

As noted above, in an embodiment, the touch surface 104 comprises of a series of rows and columns, along which signals can propagate. As discussed above, the rows and columns are designed so that, when they are not being touched, one amount of signal is coupled between them, and when they are being touched, another amount of signal is coupled between them. The change in signal coupled between them may be generally proportional or inversely proportional (although not necessarily linearly proportional) to the touch such that touch is less of a yes-no question, and more of a gradation, permitting distinction between more touch (i.e., closer or firmer) and less touch (i.e., farther or softer)—and even no touch. Moreover, a different signal is transmitted into each of the rows. In an embodiment, each of these different signals are orthogonal (i.e., separable and distinguishable) from one another. When a row and column are touched simultaneously, signal that is present on the row is coupled (positively or negatively), causing more or less to appear in the corresponding column. The quantity of the signal that is coupled onto a column may be related to the proximity, pressure or area of touch.

A receiver 103 is attached to each column. The receiver is designed to receive the signals present on the columns, including any of the orthogonal signals, or an arbitrary combination of the orthogonal signals, and any noise or other signals present. Generally, the receiver is designed to receive a frame of signals present on the columns, and to identify the columns providing signal. In an embodiment, the receiver (or a signal processor associated with the receiver data) may determine a measure associated with the quantity of each of the orthogonal transmitted signals present on that column during the time the frame of signals was captured. In this manner, in addition to identifying the rows in touch with each column, the receiver can provide additional (e.g., qualitative) information concerning the touch. In general, touch events may correspond (or inversely correspond) to the received signals on the columns. For each column, the different signals received thereon indicate which of the corresponding rows is being touched simultaneously with that column. In an embodiment, the amount of coupling between the corresponding row and column may indicate e.g., the area of the surface covered by the touch, the pressure of the touch, etc. In an embodiment, a change in coupling over time between the corresponding row and column indicates a change in touch at the intersection of the two.

### Sinusoid Illustration

In an embodiment, the orthogonal signals being transmitted onto the rows may be unmodulated sinusoids, each having a different frequency, the frequencies being chosen so that they can be distinguished from each other in the receiver. In an embodiment, frequencies are selected to provide sufficient spacing between them such that they can be more easily distinguished from each other in the receiver. In an embodiment, frequencies are selected such that no simple harmonic relationships exist between the selected frequencies. The lack of simple harmonic relationships may mitigate non-linear artifacts that can cause one signal to mimic another.

Generally, a “comb” of frequencies, where the spacing between adjacent frequencies is constant, and the highest frequency is less than twice the lowest, will meet these criteria if the spacing between frequencies, Δf, is at least the reciprocal of the measurement period τ. For example, if it is desired to measure a combination of signals (from a column, for example) to determine which row signals are present once per millisecond (τ), then the frequency spacing (Δf) must be greater than one kilohertz (i.e., Δf>1/τ). According to this calculation, in an example case with only ten rows, one could use the following frequencies:
Row 1: 5.000 MHz
Row 2: 5.001 MHz
Row 3: 5.002 MHz
Row 4: 5.003 MHz
Row 5: 5.004 MHz
Row 6: 5.005 MHz
Row 7: 5.006 MHz
Row 8: 5.007 MHz
Row 9: 5.008 MHz
Row 10: 5.009 MHz

It will be apparent to one of skill in the art in view of this disclosure that frequency spacing may be substantially greater than this minimum to permit robust design. As an example, a 20 cm by 20 cm touch surface with 0.5 cm row/column spacing would require forty rows and forty columns and necessitate sinusoids at forty different frequencies. While a once per millisecond analysis rate would require only 1 KHz spacing, an arbitrarily larger spacing is utilized for a more robust implementation. In an embodiment, the arbitrarily larger spacing is subject to the constraint that the maximum frequency should not be more than twice the lowest (i.e., fₘₐₓ<2(fₘᵢₙ₎). Thus, in this example, a frequency spacing of 100 kHz with the lowest frequency set at 5 MHz may be used, yielding a frequency list of 5.0 MHz, 5.1 MHz, 5.2 MHz, etc. up to 8.9 MHz.

In an embodiment, each of the sinusoids on the list may be generated by a signal generator and transmitted on a separate row by a signal emitter or transmitter. To identify the rows and columns that are being simultaneously touched, a receiver receives any signals present on the columns and a signal processor analyzes the signal to determine which, if any, frequencies on the list appear. In an embodiment, the identification can be supported with a frequency analysis technique (e.g., Fourier transform), or by using a filter bank. In an embodiment, the receiver receives a frame of column signals, which frame is processed through an FFT, and thus, a measure is determined for each frequency. In an embodiment, the FFT provides an in-phase and quadrature measure for each frequency, for each frame.

In an embodiment, from each column's signal, the receiver/signal processor can determine a value (and potentially an in-phase and quadrature value) for each frequency from the list of frequencies found in the signal on that column. In an embodiment, where the value of a frequency is greater or lower than some threshold, or changes from the prior value, the signal processor identifies there being a touch event between the column and the row corresponding to that frequency. In an embodiment, signal strength information, which may correspond to various physical phenomena including the distance of the touch from the row/column intersection, the size of the touch object, the pressure with which the object is pressing down, the fraction of row/column intersection that is being touched, etc. may be used as an aid to localize the area of the touch event. In an embodiment, the determined values are not self-determinative of touch, but rather are further processed along with other values to determine touch events.

Once values for each of the orthogonal frequencies have been determined for at least two frequencies (corresponding to rows) or for at least two columns, a two-dimensional map can be created, with the value being used as, or proportional/inversely proportional to, a value of the map at that row/column intersection. In an embodiment, values are determined at multiple row/column intersections on a touch surface to produce a map for the touch surface or region. In an embodiment, values are determined for every row/column intersection on a touch surface, or in a region of a touch surface, to produce a map for the touch surface or region. In an embodiment, the signals' values are calculated for each frequency on each column. Once signal values are calculated a two-dimensional map may be created. In an embodiment, the signal value is the value of the map at that row/column intersection. In an embodiment, the signal value is processed to reduce noise before being used as the value of the map at that row/column intersection. In an embodiment, another value proportional, inversely proportional or otherwise related to the signal value (either after being processed to reduce noise) is employed as the value of the map at that row/column intersection. In an embodiment, due to physical differences in the touch surface at different frequencies, the signal values are normalized for a given touch or calibrated. Similarly, in an embodiment, due to physical differences across the touch surface or between the intersections, the signal values need to be normalized for a given touch or calibrated.

In an embodiment, the two-dimensional map data may be thresholded to better identify, determine or isolate touch events. In an embodiment, the two-dimensional map data may be used to infer information about the shape, orientation, etc. of the object touching the surface.

In an embodiment, such analysis and any touch processing described herein is performed on a touch sensor's discrete touch controller. In another embodiment, such analysis and touch processing could be performed on other computer system components such as but not limited to one or more ASIC, MCU, FPGA, CPU, GPU, SoC, DSP or dedicated circuit. The term “hardware processor” as used herein means any of the above devices or any other device which performs computational functions.

Returning to the discussion of the signals being transmitted on the rows, a sinusoid is not the only orthogonal signal that can be used in the configuration described above. Indeed, as discussed above, any set of signals that can be distinguished from each other will work. Nonetheless, sinusoids may have some advantageous properties that may permit simpler engineering and more cost efficient manufacture of devices which use this technique. For example, sinusoids have a very narrow frequency profile (by definition), and need not extend down to low frequencies, near DC. Moreover, sinusoids can be relatively unaffected by 1/f noise, which noise could affect broader signals that extend to lower frequencies.

In an embodiment, sinusoids may be detected by a filter bank. In an embodiment, sinusoids may be detected by frequency analysis techniques (e.g., Fourier transform/fast Fourier transform). Frequency analysis techniques may be implemented in a relatively efficient manner and may tend to have good dynamic range characteristics, allowing them to detect and distinguish between a large number of simultaneous sinusoids. In broad signal processing terms, the receiver's decoding of multiple sinusoids may be thought of as a form of frequency-division multiplexing. In an embodiment, other modulation techniques such as time-division and code-division multiplexing could also be used. Time division multiplexing has good dynamic range characteristics, but typically requires that a finite time be expended transmitting into (or analyzing received signals from) the touch surface. Code division multiplexing has the same simultaneous nature as frequency-division multiplexing, but may encounter dynamic range problems and may not distinguish as easily between multiple simultaneous signals.

### Modulated Sinusoid Illustration

In an embodiment, a modulated sinusoid may be used in lieu of, in combination with and/or as an enhancement of, the sinusoid embodiment described above. The use of unmodulated sinusoids may cause radiofrequency interference to other devices near the touch surface, and thus, a device employing them might encounter problems passing regulatory testing (e.g., FCC, CE). In addition, the use of unmodulated sinusoids may be susceptible to interference from other sinusoids in the environment, whether from deliberate transmitters or from other interfering devices (perhaps even another identical touch surface). In an embodiment, such interference may cause false or degraded touch measurements in the described device.

In an embodiment, to avoid interference, the sinusoids may be modulated or “stirred” prior to being transmitted by the transmitter in a manner that the signals can be demodulated (“unstirred”) once they reach the receiver. In an embodiment, an invertible transformation (or nearly invertible transformation) may be used to modulate the signals such that the transformation can be compensated for and the signals substantially restored once they reach the receiver. As will also be apparent to one of skill in the art, signals emitted or received using a modulation technique in a touch device as described herein will be less correlated with other things, and thus, act more like mere noise, rather than appearing to be similar to, and/or being subject to interference from, other signals present in the environment.

In an embodiment, a modulation technique utilized will cause the transmitted data to appear fairly random or, at least, unusual in the environment of the device operation. Two modulation schemes are discussed below: Frequency Modulation and Direct Sequence Spread Spectrum Modulation.

### Frequency Modulation

Frequency modulation of the entire set of sinusoids keeps them from appearing at the same frequencies by “smearing them out.” Because regulatory testing is generally concerned with fixed frequencies, transmitted sinusoids that are frequency modulated will appear at lower amplitudes, and thus be less likely to be a concern. Because the receiver will “un-smear” any sinusoid input to it, in an equal and opposite fashion, the deliberately modulated, transmitted sinusoids can be demodulated and will thereafter appear substantially as they did prior to modulation. Any fixed frequency sinusoids that enter (e.g., interfere) from the environment, however, will be “smeared” by the “unsmearing” operation, and thus, will have a reduced or an eliminated effect on the intended signal. Accordingly, interference that might otherwise be caused to the sensor is lessened by employing frequency modulation, e.g., to a comb of frequencies that, in an embodiment, are used in the touch sensor.

In an embodiment, the entire set of sinusoids may be frequency modulated by generating them all from a single reference frequency that is, itself, modulated. For example, a set of sinusoids with 100 kHz spacing can be generated by multiplying the same 100 kHz reference frequency by different integers. In an embodiment, this technique can be accomplished using phase-locked loops. To generate the first 5.0 MHz sinusoid, one could multiply the reference by 50, to generate the 5.1 MHz sinusoid, one could multiply the reference by 51, and so forth. The receiver can use the same modulated reference to perform the detection and demodulation functions.

### Direct Sequence Spread Spectrum Modulation

In an embodiment, the sinusoids may be modulated by periodically inverting them on a pseudo-random (or even truly random) schedule known to both the transmitter and receiver. Thus, in an embodiment, before each sinusoid is transmitted to its corresponding row, it is passed through a selectable inverter circuit, the output of which is the input signal multiplied by +1 or −1 depending on the state of an “invert selection” input. In an embodiment, all of these “invert selection” inputs are driven from the same signal, so that the sinusoids for each row are all multiplied by either +1 or −1 at the same time. In an embodiment, the signal that drives the “invert selection” input may be a pseudorandom function that is independent of any signals or functions that might be present in the environment. The pseudorandom inversion of the sinusoids spreads them out in frequency, causing them to appear like random noise so that they interfere negligibly with any devices with which they might come in contact.

On the receiver side, the signals from the columns may be passed through selectable inverter circuits that are driven by the same pseudorandom signal as the ones on the rows. The result is that, even though the transmitted signals have been spread in frequency, they are despread before the receiver because they have been multiplied by either +1 or −1 twice, leaving them in, or returning them to, their unmodified state. Applying direct sequence spread spectrum modulation may spread out any interfering signals present on the columns so that they act only as noise and do not mimic any of the set of intentional sinusoids.

In an embodiment, selectable inverters can be created from a small number of simple components and/or can be implemented in transistors in a VLSI process.

Because many modulation techniques are independent of each other, in an embodiment, multiple modulation techniques could be employed at the same time, e.g., frequency modulation and direct sequence spread spectrum modulation of the sinusoid set. Although potentially more complicated to implement, such multiple modulated implementation may achieve better interference resistance.

Because it would be extremely rare to encounter a particular pseudo random modulation in the environment, it is likely that the multi-touch sensors described herein would not require a truly random modulation schedule. One exception may be where more than one touch surface with the same implementation is being touched by the same person. In such a case, it may be possible for the surfaces to interfere with each other, even if they use very complicated pseudo random schedules. Thus, in an embodiment, care is taken to design pseudo random schedules that are unlikely to conflict. In an embodiment, some true randomness may be introduced into the modulation schedule. In an embodiment, randomness is introduced by seeding the pseudo random generator from a truly random source and ensuring that it has a sufficiently long output duration (before it repeats). Such an embodiment makes it highly unlikely that two touch surfaces will ever be using the same portion of the sequence at the same time. In an embodiment, randomness is introduced by exclusive or'ing (XOR) the pseudo random sequence with a truly random sequence. The XOR function combines the entropy of its inputs, so that the entropy of its output is never less than either input.

### A Low-Cost Implementation Illustration

Touch surfaces using the previously described techniques may have a relatively high cost associated with generating and detecting sinusoids compared to other methods. Below are discussed methods of generating and detecting sinusoids that may be more cost-effective and/or be more suitable for mass production.

### Sinusoid Detection

In an embodiment, sinusoids may be detected in a receiver using a complete radio receiver with a Fourier Transform detection scheme. Such detection may require digitizing a high-speed RF waveform and performing digital signal processing thereupon. Separate digitization and signal processing may be implemented for every column of the surface; this permits the signal processor to discover which of the row signals are in touch with that column. In the above-noted example, having a touch surface with forty rows and forty columns, would require forty copies of this signal chain. Today, digitization and digital signal processing are relatively expensive operations, in terms of hardware, cost, and power. It would be useful to utilize a more cost-effective method of detecting sinusoids, especially one that could be easily replicated and requires very little power.

In an embodiment, sinusoids may be detected using a filter bank. A filter bank comprises an array of bandpass filters that can take an input signal and break it up into the frequency components associated with each filter. The Discrete Fourier Transform (DFT, of which the FFT is an efficient implementation) is a form of a filter bank with evenly-spaced bandpass filters that may be used for frequency analysis. DFTs may be implemented digitally, but the digitization step may be expensive. It is possible to implement a filter bank out of individual filters, such as passive LC (inductor and capacitor) or RC active filters. Inductors are difficult to implement well on VLSI processes, and discrete inductors are large and expensive, so it may not be cost effective to use inductors in the filter bank.

At lower frequencies (about 10 MHz and below), it is possible to build banks of RC active filters on VLSI. Such active filters may perform well, but may also take up a lot of die space and require more power than is desirable.

At higher frequencies, it is possible to build filter banks with surface acoustic wave (SAW) filter techniques. These allow nearly arbitrary FIR filter geometries. SAW filter techniques require piezoelectric materials which are more expensive than straight CMOS VLSI. Moreover, SAW filter techniques may not allow enough simultaneous taps to integrate sufficiently many filters into a single package, thereby raising the manufacturing cost.

In an embodiment, sinusoids may be detected using an analog filter bank implemented with switched capacitor techniques on standard CMOS VLSI processes that employs an FFT-like “butterfly” topology. The die area required for such an implementation is typically a function of the square of the number of channels, meaning that a 64-channel filter bank using the same technology would require only 1/256th of the die area of the 1024-channel version. In an embodiment, the complete receive system for the low-latency touch sensor is implemented on a plurality of VLSI dies, including an appropriate set of filter banks and the appropriate amplifiers, switches, energy detectors, etc. In an embodiment, the complete receive system for the low-latency touch sensor is implemented on a single VLSI die, including an appropriate set of filter banks and the appropriate amplifiers, switches, energy detectors, etc. In an embodiment, the complete receive system for the low-latency touch sensor is implemented on a single VLSI die containing n instances of an n-channel filter bank, and leaving room for the appropriate amplifiers, switches, energy detectors, etc.

### Sinusoid Generation

Generating the transmit signals (e.g., sinusoids) in a low-latency touch sensor is generally less complex than detection, principally because each row requires the generation of a single signal while the column receivers have to detect and distinguish between many signals. In an embodiment, sinusoids can be generated with a series of phase-locked loops (PLLs), each of which multiply a common reference frequency by a different multiple.

In an embodiment, the low-latency touch sensor design does not require that the transmitted sinusoids are of very high quality, but rather, accommodates transmitted sinusoids that have more phase noise, frequency variation (over time, temperature, etc.), harmonic distortion and other imperfections than may usually be allowable or desirable in radio circuits. In an embodiment, the large number of frequencies may be generated by digital means and then employ a relatively coarse digital-to-analog conversion process. As discussed above, in an embodiment, the generated row frequencies should have no simple harmonic relationships with each other, any non-linearities in the described generation process should not cause one signal in the set to “alias” or mimic another.

In an embodiment, a frequency comb may be generated by having a train of narrow pulses filtered by a filter bank, each filter in the bank outputting the signals for transmission on a row. The frequency “comb” is produced by a filter bank that may be identical to a filter bank that can be used by the receiver. As an example, in an embodiment, a 10 nanosecond pulse repeated at a rate of 100 kHz is passed into the filter bank that is designed to separate a comb of frequency components starting at 5 MHz, and separated by 100 kHz. The pulse train as defined would have frequency components from 100 kHz through the tens of MHz, and thus, would have a signal for every row in the transmitter. Thus, if the pulse train were passed through an identical filter bank to the one described above to detect sinusoids in the received column signals, then the filter bank outputs will each contain a single sinusoid that can be transmitted onto a row.

### Illustration of Touchpad Embodiment

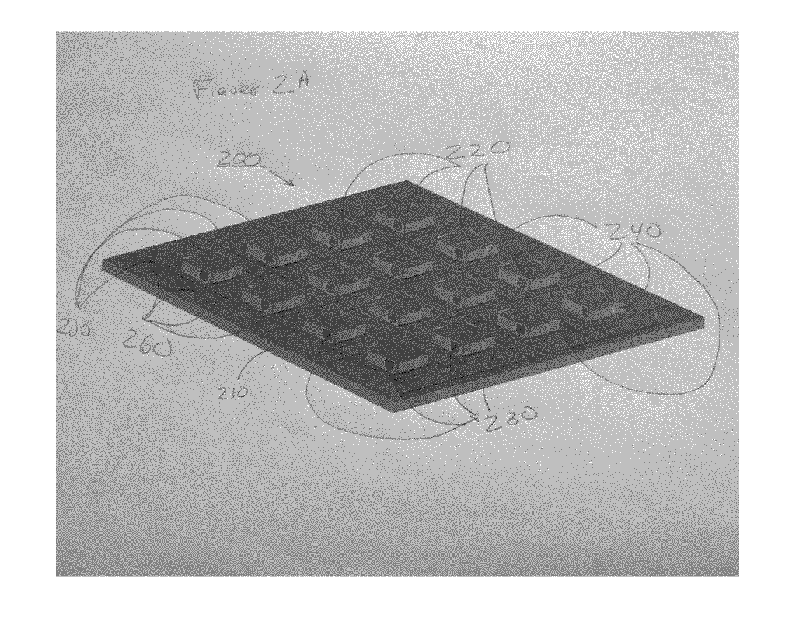

Turning now to FIGS. 2A and 2B, two views of one exemplary embodiment of a touchpad sensor is shown. The illustrative touchpad sensor 200 has a base 210. Extending from the base 210 are a plurality of protrusions 220 that can support row antennae 230 and column antennae 240. The base may be made from any suitable material. In an embodiment, a non-conductive material is used for the base. In an embodiment, where a rigid touchpad sensor is desired, the base may be made of a rigid non-conductive plastic. In an embodiment, where a non-rigid touchpad sensor is desired, a less rigid material may be used such as silicone, rubber or any flexible or generally elastomeric material.

As can be seen in FIG. 2, row antennae 230 are present on opposite sides of the protrusions 220 from each other, and column antennae 240 are present on opposite sides of the protrusions 220 from each other and on adjacent sides with the antennae from row antennae groups 230. In an embodiment, row antennae 230 are organized into logical rows. In the illustrated example of FIG. 2, there are 8 rows (groups) having four row antenna 230 in each group (4 of the 8 rows are more difficult to see as they are on the opposite side of the protrusions 220). In an embodiment, as shown, the logical rows correspond to the physical rows. Row traces 250 conductively couple each of the four row antennae 230 into a group. In an embodiment, row traces 250 are copper traces on an assembly layer.

As with the row antennae 230, in the illustrated example of FIG. 2, there are 8 columns (groups) having four column antennae 240 in each group (as above, 4 of the 8 rows are more difficult to see). In an embodiment, as shown, the logical columns correspond to the physical columns. And as with the row traces 250, column traces 260 conductively couple groups of four column antennae 240 into a group. In an embodiment, column traces 260 are copper traces on an assembly layer.

In an embodiment, row traces 250 and column traces 260 may be traces on the opposite sides of an assembly layer. In an embodiment, row traces 250 and column traces 260 are copper traces on the opposite sides of an assembly layer. In an embodiment, one of the row traces 250 and the column traces 260 are traces on the base 210.

In an embodiment, the protrusions 220 are generally square in shape, and the horizontal and vertical space between the various protrusions 220 is of substantially the same dimension as the protrusions 220 themselves. Thus, in an example embodiment, the protrusions 220 are 8 mm squares, and protrude approximately 2 mm out of the rest of the base 210; and the protrusions 220 are each 8 mm from each of their neighboring protrusions 220. In an embodiment, the protrusions 220 are between 5 and 25 mm squares, and protrude between 1 and 10 mm out of the rest of the base 210. In an embodiment, the protrusions 220 are each spaced from their neighboring protrusions 220 by approximately the same amount as one side of the protrusion's square dimension. In an embodiment, the protrusions 220 are each spaced from its neighboring protrusion by a distance greater than one side of its square dimension. In an embodiment, row antenna 230 and column antennae 240 may interact, not only with the antennae on their respective protrusion 220, but also antennae on adjacent protrusions. In an embodiment, the protrusions 220 are each spaced from its neighbors by a distance less than one side of its square dimension. In an embodiment, the antenna 230, 240 can be shifted such that it is only partially supported by the protrusion 220. For example, if only half of a respective antenna 230, 240 were supported by the protrusion 220, the antenna 230, 240 would be equidistant from the other four antennae 230, 240. Generally, in an embodiment, the protrusions are designed to support the row antennae 230 and column antennae 240 such that the antennae form a desired pattern. In an embodiment, a desired pattern of antennae, as shown in FIG. 2, is made such that—except at the edges—each antenna from a row antennae group 230 is approximately equidistant from, and at right angles to, four antennae from column antennae groups 240, and vice-versa.

A cover, not shown may be placed over the base, including the protrusions and antenna to provide a smooth or uniform surface for the touchpad. The cover can also be used to protect the antennae, and to hold the antennae in position. The cover can be made of any suitable non-conductive material. In an embodiment, the cover can be made of mildly conductive material. In an embodiment, the cover may have embedded within its thickness, units of conductive material, such as disks or squares of conductive material.

As will be apparent to one of skill in the art in view of this disclosure, the touchpad may be made in substantially any size. The illustrated example having 64 antennae is merely illustrative. Touchpads may be designed with many more antennae, and the antennae spacing and orientation may be varied without departing from the spirit or scope of the present disclosure, depending on the size of the touchpad and its application. Similarly, the selection of sixteen protrusions is also merely illustrative. No protrusions are required, and the protrusions are merely a potential manufacturing convenience. To the extent that the antennae are self-supporting or supported by other means, the protrusions are unnecessary. For example, in an embodiment, the antennae may be positioned and then molded into place within a resin or plastic, obviating the need for the protrusions.

Each of the row traces 250 may be connected to a signal emitter or a signal receiver (not shown). Where the row traces 250 are connected to a signal emitter, each of the column traces 260 is connected to a signal receiver, and vice-versa. Orthogonal signals are simultaneously transmitted by the signal emitters, and sequential frames of signals are received by the signal receiver. A signal processor can determine a measurement of each of the orthogonal signals present on each of the column traces 260 during the frame-time, and changes in these measurements from frame to frame are used to determine touch.

Although shown in FIGS. 2A and 2B, it is not necessary that the logical rows correspond to the physical rows and the logical columns correspond to the physical columns. Benefits can be derived from having the logical rows differ from the physical rows, and/or by having the logical columns differ from the physical columns.

In an embodiment, the row antennae 230 are grouped into groups having fewer than the illustrated four antennae. Such an embodiment would require additional row traces 250. In an embodiment, each row trace 250 is conductively coupled to only one antenna. In an embodiment, the row antennae 230 are grouped into groups having more antennae than the illustrated four antennae. Such an embodiment may require fewer row traces 250. In an embodiment, a single row trace 250 is conductively coupled to all of the row antennae 230. The same more or fewer antenna per group can be applied to the column antennae 240 and column traces 260. Moreover, it is not necessary to have identical numbers of antennae in the antennae groups.

The embodiment illustrated in FIGS. 2A and 2B may be deployed with eight signal emitters (e.g., one for each row trace), and eight signal receivers (e.g., one for each column trace). Other combinations are possible, and will be apparent to a person of ordinary skill in the art in view of this disclosure. For example, in an embodiment, the first and fifth, second and sixth, third and seventh and fourth and eighth row traces could be connected, thus requiring only four signal emitters. Or, for example, in an embodiment, each of the eight row traces could be severed between the second and third antennae, and sixteen separate signal emitters could be deployed. Moreover, in an embodiment, one signal emitter is conductively coupled to each row antennae, each of the signal emitters being adapted to output a frequency orthogonal to, and simultaneously with, each of the other signal emitters; and one signal receiver may be conductively coupled to all of the column antennae.

In an embodiment, a GPS-like calculation is performed on the strength of signal from the four closest neighbors, after accounting for the fact that two of the neighbors are from the same transmitter.

In an embodiment, the protrusions are not necessary at all, as the purpose of each protrusion is to support the antennae. In an embodiment, row antennae and column antennae do not require support from the protrusions. In an embodiment, protrusions each support one antenna. In an embodiment, protrusions each support two antennae. In an embodiment, protrusions each support more than four antennae.

The touchpad as described above may permit object detection in the hover space up to about 2 inches above the touchpad. In an embodiment, the touchpad could have designated key spaces thereon and operate as a keyboard. In an embodiment, the touchpad could be used in a VR or AR space, and have designated key spaces illustrated only in the VR or AR world. In an embodiment, the granular touchpad data can be used to model a user's fingers and hands so that a user can see his hands as though they were on a keyboard in a VR space.

The 64 antennae illustration in FIGS. 2A and 2B are just an example. It will be apparent to a person of skill in the art in view of this disclosure that many more antennae can be used. For example, where a cascading integrated circuit (as discussed below) is employed, hundreds of simultaneous orthogonal frequencies can be transmitted and measured at hundreds of receive channels.

The orientation of the antennae in the illustrative embodiment, (except in edge cases) permits each transmitter to interact with numerous receivers, and likewise, each receiver to interact with numerous transmitters. Specifically, in the illustrated embodiment, (again, except in edge cases) each transmitter is proximate to four receivers, and each receiver is proximate to four transmitters. Spacing of antennae on the protrusions, and spacing of protrusion to protrusion are variables that can be altered to tune the ratio of nearest receive antenna to the adjacent transmit or receive antennae. In an embodiment, (again, except in edge cases) each transmitter may be proximate to a plurality of receivers, and each receiver may be proximate to a plurality of transmitters. In an embodiment, (again, except in edge cases) each transmitter may be substantially equidistant from a plurality of receivers, and each receiver may be proximate to a plurality of transmitters.

The illustrated antennae orientation creates a type of bi-phase detection. After efficiently processing the signal using, for example, an FFT, each bin is likely to have equal baseline amounts at four different receive antennae. In the illustrated simple squares embodiment, two of those four are the same RX channel, but that is not required, and may be easily designed around if the duplication causes processing issues. Using the illustrated configuration, confusion of a touch object may be resolved by the relative strength of signal on two bin receive channel intersections, instead of just one.

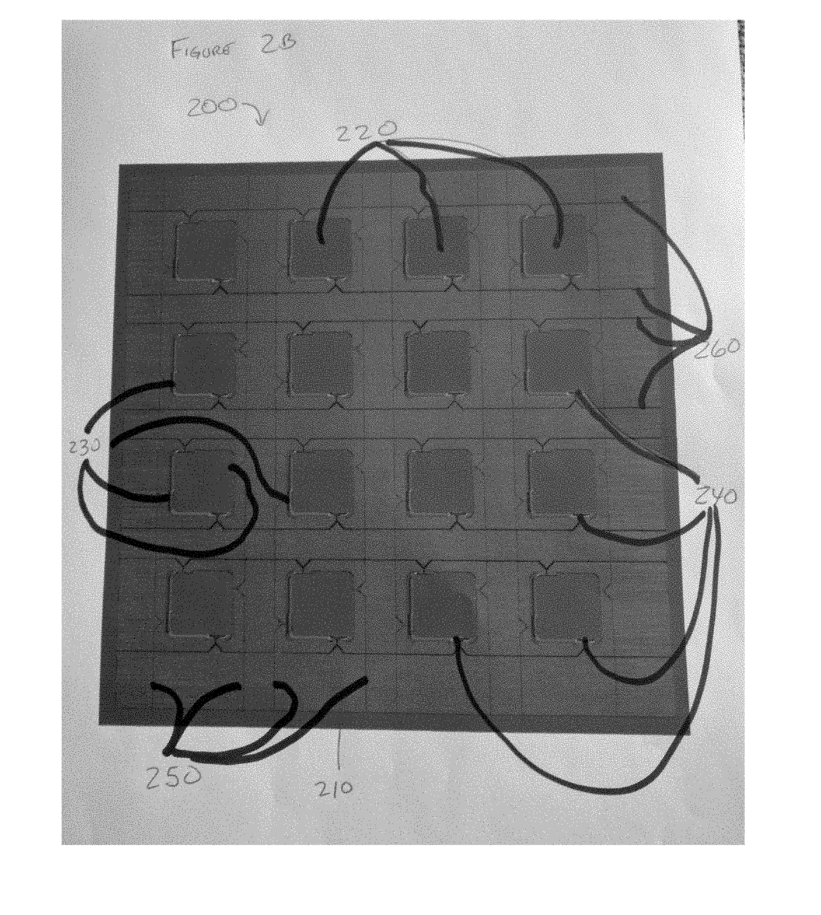

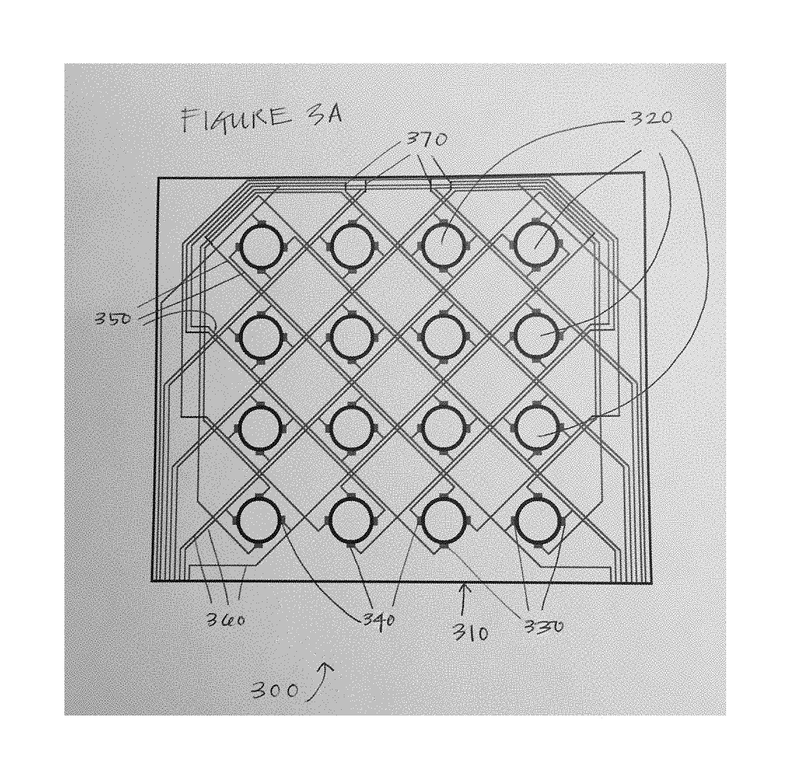

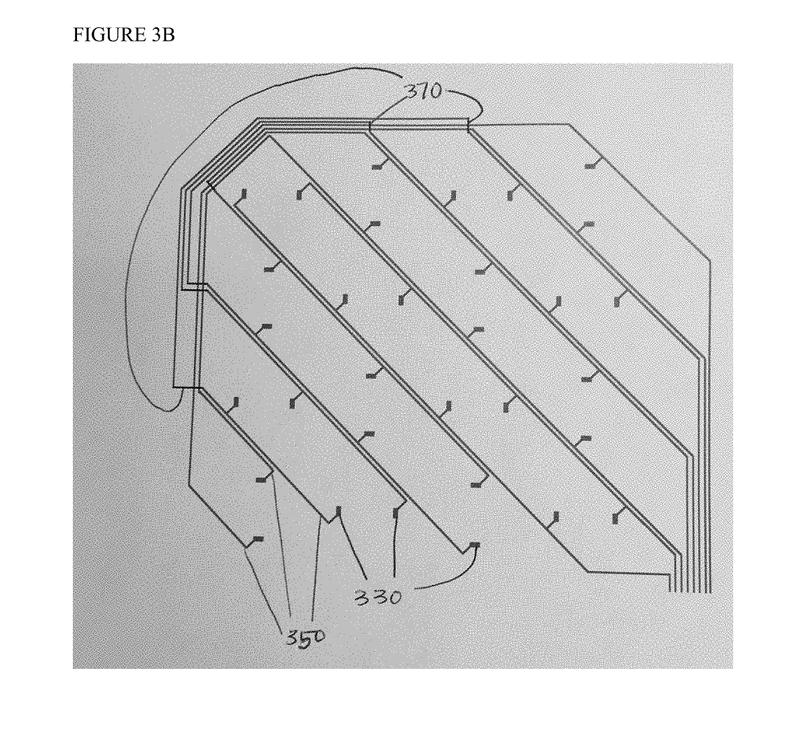

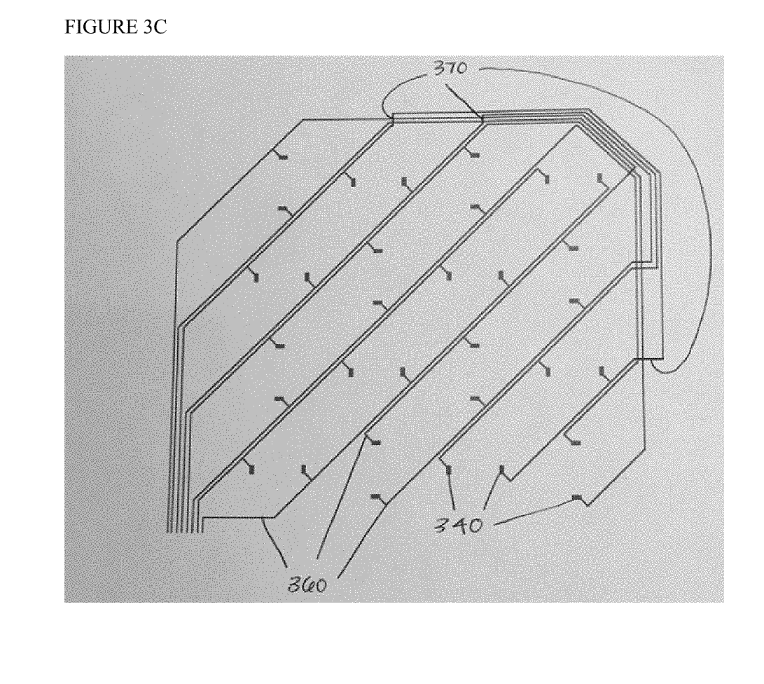

In an embodiment, the protrusions may be formed in shapes other than square. Turning to FIG. 3A, a plan view of components of another embodiment of a touchpad 300 is shown. Short cylindrical protrusions 320 extend from the base 310 to support row antennae 330 and column antennae 340. In the illustrated example, row traces 350 conductively couple the row antennae 330 and column traces 360 conductively couple the column antennae 340. In an embodiment, the row traces 350 can be conductively coupled such that the row traces 360 form eight rows each having four row antennae 330. In an embodiment, trace jumps 370 are used when row traces 350 or column traces 360 would otherwise cross one another. In the illustrated embodiment there are 14 separate groups of row antennae 330 and 14 separate groups of column antennae 340. Moreover, in the illustrated embodiment, the groups of row antenna 330 and column antenna 340 have as few as one antenna, and as many as four antennae grouped together by a single trace. In the embodiment illustrated in FIG. 3A, the position and orientation of the antennae ensure that the three closest transmitters to each receiver have different signals, and the three closest receivers to each transmitter are on separate channels.

In another embodiment, in FIG. 3B, one layer of the composite touchpad 300 of FIG. 3A is shown without its base 310. In the illustrated example, row traces 350 conductively couple the row antennae 330, and trace jumps 370 are used when row traces 350 would otherwise cross one another. FIG. 3C shows another layer of the composite touchpad 300 of FIG. 3A without its base 310. In the illustrated example, column traces 360 conductively couple the column antennae 340; and trace jumps 370 are used when row traces 350 would otherwise cross one another.

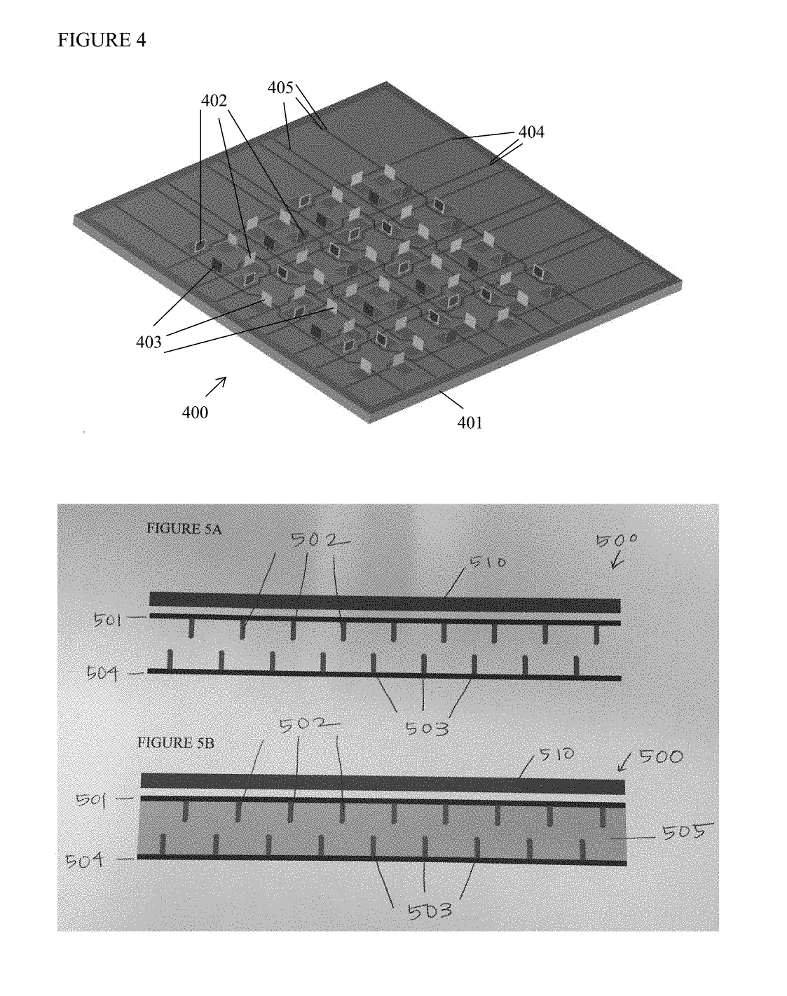

Turning to FIG. 4, which shows another illustrative embodiment of a plan view of components of an illustrative touchpad 400 with a base 401. In an illustrative embodiment, FIG. 4 has sixty-four antennae 402, 403 shown. In an embodiment, the dimension between each antenna is equidistant. The illustrative embodiment has sixteen rows of two row antennae 402 each, and sixteen columns of two column antennae 403 each. In an embodiment, a plurality of rows are used, and each row has at least one antenna associated therewith. In an embodiment, a plurality of columns are used, and each column has at least one antenna associated therewith. In an embodiment, each column receiver (not shown) sees four row antennae 402 of substantially equal magnitude due to the positioning of the respective antennae. As would be understood by one of skill in the art in light of this disclosure, in an embodiment there may be: more row antennae 402, and the same number, or more or fewer logical rows; fewer row antennae 402 and the same number, or more or fewer logical rows; more column antennae 403 and the same number, or more or fewer logical columns, and/or fewer column antennae and the same number, or more or fewer logical columns, as suits the purpose of the touch detector, and that sixty-four antennae 402, 403 organized into sixteen logical rows and columns was selected for illustrative purposes. Similarly, the physical size, spacing and positioning of the illustrated antennae are for illustrative purposes; the touch detector need not be square, or have a similar number of physical rows or columns.

In an embodiment, each of the plurality of row antennae 402 are positioned such that at least two of the plurality of column antennae 403 are equidistant therefrom. In an embodiment, each of the plurality of column antennae 403 being positioned such that at least two of the plurality of row antennae 402 are equidistant therefrom. In an embodiment, each of the plurality of row antennae 402 are positioned such that at least two of the plurality of column antennae 403 are equidistant therefrom and each of the plurality of column antennae 403 being positioned such that at least two of the plurality of row antennae 402 are equidistant therefrom.

In an embodiment, each of the plurality of row antennae 402 are positioned such that four of the plurality of column antennae 403 are equidistant therefrom. In an embodiment, each of the plurality of column antennae 403 being positioned such that four of the plurality of row antennae 402 are equidistant therefrom. In an embodiment, each of the plurality of row antennae 402 are positioned such that four of the plurality of column antennae 403 are equidistant therefrom and each of the plurality of column antennae 403 being positioned such that four of the plurality of row antennae 402 are equidistant therefrom.

In an embodiment, the row traces 404 or the column traces 405 may be traces on the underside of the touch surface. In an embodiment, the row traces 404 and the column traces 405 may be traces on opposite sides of the same substrate. In an embodiment, the row traces 404 and the column traces 405 are traces on separate substrates. In an embodiment, a substrate having row traces 404 is sandwiched together with a substrate having column traces 405. In an embodiment, a substrate having row traces 404 and a substrate having column traces 405 are sandwiched together beneath the touch surface. In an embodiment, the row traces 404 are traces on the underside of the touch surface, and the column traces 405 are traces on the upper side of a base portion of the touch detector.

### Antennae Positioning and Spacing

As can be seen in the illustrated embodiments, there are many positions and orientations that will be suitable for operation of the disclosed touch detector. In one embodiment, the closest neighboring transmitters with each receiver should be associated with separate logical rows, and thus each transmit orthogonal frequency. In an embodiment, farther neighboring transmitters to each receiver would also transmit frequencies orthogonal to each other and the nearer neighbors. In an embodiment, from a sensitivity standpoint, it may be desirable to position the transmit antennae such that every one of them is as far away as possible (or far enough to avoid interference at a receiver) from all of the other transmit antennae that share the same logical row.

As will be apparent to one of skill in the art in view of this disclosure, in an embodiment, it is also desirable to organize the receive antennae such that neighboring receivers are associated with separate logical columns. In an embodiment, from a sensitivity standpoint, it may be desirable to position the receive antennae such that every one of them is as far away as possible (or far enough to avoid interference) from all of the other receive antennae that share the same logical column.

In an embodiment, the row antennae are organized into N logical rows—where N is at least two. In an embodiment, the N logical rows are different than any physical rows in which the row antennae are positioned. In an embodiment, each the row antennae associated one of the N logical rows is spaced further apart from each other row antenna associated with the same logical row than from at least one row antennae not associated with that logical row.

In an embodiment, the column antennae are organized into M logical columns—where M is at least two. In an embodiment, the M logical columns are different than any physical columns in which the column antennae are positioned. In an embodiment, each the column antennae associated one of the M logical columns is spaced further apart from each other column antenna associated with the same logical column than from at least one column antennae not associated with that logical column.

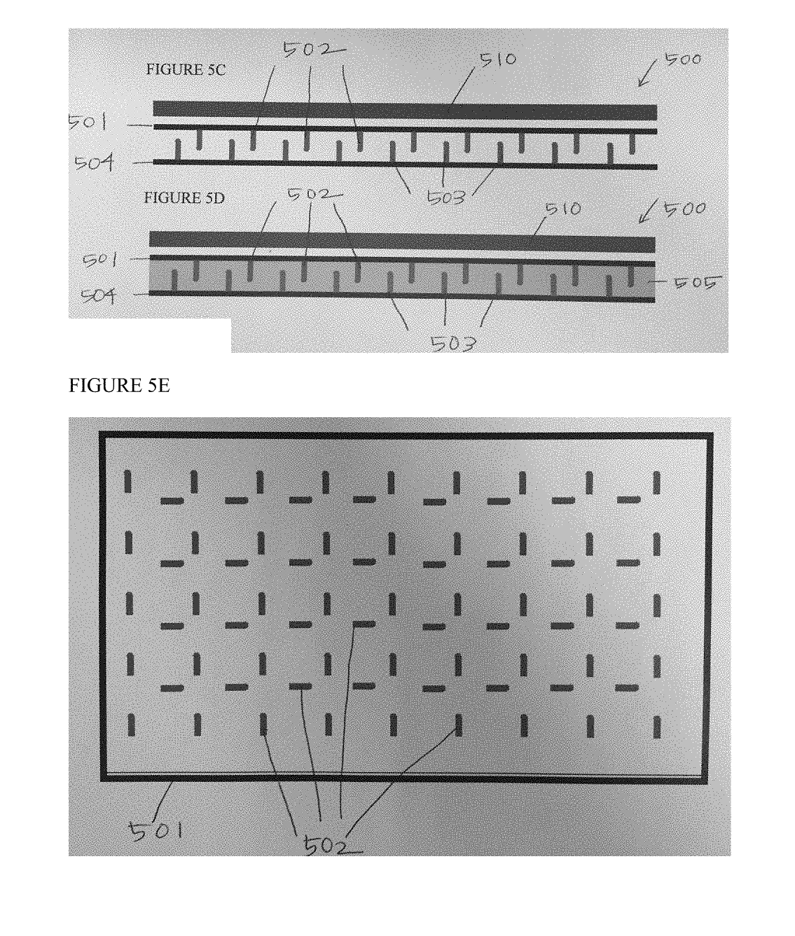

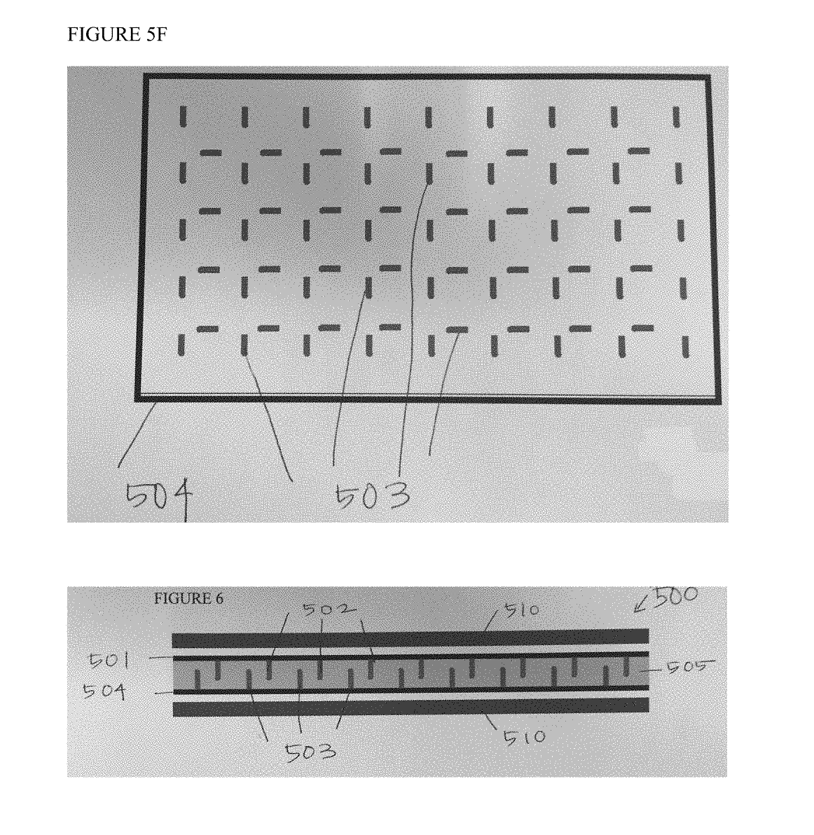

In an embodiment, it may also be desirable to have one layer containing row antennae and another layer containing column antennae as illustrated in the embodiments shown in FIGS. 5A-F. FIGS. 5A-D are diagrammatic representations of a touchpad 500, having a touch surface 510, with a row antennae layer 501 and a column antennae layer 504. The row antennae layer 501 comprising row antennae 502, and the column antennae layer 504 comprising column antennae 503. In an embodiment, the antennae 502, 503 are oriented such that they are normal to their respective layers 501, 504. In an embodiment, the antennae 502, 503 are oriented such that they are at an angle with respect to their respective layers 501, 504. In an embodiment, the antennae 502, 503 are oriented such that they are at an angle of between 45 degrees and normal with respect to their respective layers 501, 504. In an embodiment, the antennae 502, 503 are oriented such that they are at an angle of between 60 degrees and 75 degrees with respect to their respective layers 501, 504.

In an embodiment, the antennae 502, 503 may be oriented such that the antennae from one layer 502 face the antennae from the other layer 503, Antennae 502, 503 may be oriented such that a broader face of the antennae from one layer 502 face a broader face of the antennae from the other layer 503. As shown in FIGS. 5A-B, in an embodiment, the antennae layers 501, 504 are spaced, and the antennae 502, 503 are sized such that the proximate ends of the row antennae 502 do not fall between the proximate ends of the column antennae 503. The layers 501, 504 may, however, be spaced closer and/or the antennae may project farther from their respective layers. Thus, as shown in FIGS. 5C-D, in an embodiment, the antennae layers 501, 504 are spaced, and the antennae 502, 503 are sized such that the proximate ends of the row antennae 502 fall between the proximate ends of the column antennae 503. As shown in FIGS. 5C-D, in an embodiment, at least a portion of the faces of the row antennae 502 are parallel and directly opposite at least a portion of the faces of the column antennae 503.

As shown in FIGS. 5B and D, in an embodiment, a flexible foam, gel, silicon, or other mechanically deformable substance 505 is placed between the layers 501, 504, and thus, the antennae 502, 503. In an embodiment, the flexible foam, gel, silicon, or other mechanically deformable substance 505 is dielectric or has dielectric properties.

In an embodiment, the touch surface 510 is made from a protective material. In an embodiment, the touch surface 510 is made out of glass. In an embodiment, the touch surface 510 is opaque. In an embodiment, the touch surface 510 may be made out of a thin flexible glass. An example of one such flexible glass is Willow® Glass manufactured by Corning Inc.

FIG. 5E shows an illustration of the row antennae on the row antennae layer 504 of the touchpad described herein. FIG. 5F shows an illustration of the column antennae on the column antennae layer 504 of the touchpad described herein. The respective layers of FIGS. 5E and F can be overlaid to form the illustrative embodiments shown in FIGS. 5A-D and 6 (described below).

Turning for a moment to FIG. 6, in an embodiment, multiple touch surfaces 510 may be deployed outside each of the layers 501, 504. Where the upper and lower touch surfaces 510 are made from, e.g., Willow® Glass, or a similar flexible material, touch can be detected from both sides of the touchpad 500.

In an embodiment, a touch surface 510 covers at least one of the layers 501, 504. In an embodiment, the application of a force, such as a touch on the touch surface 510 may deform the substance 505, changing the positioning of the row antennae 502 relative to the column antennae 503. In an embodiment, the change in relative positioning of corresponding (and/or facing) pairs of row antennae 502 and column antennae 503 may result in an increase in coupling of signal therebetween. In an embodiment, the change in relative positioning of corresponding (and/or facing) pairs of row antennae 502 and column antennae 503 may result in a decrease in coupling of signal therebetween.

### Integrated Circuit Illustration

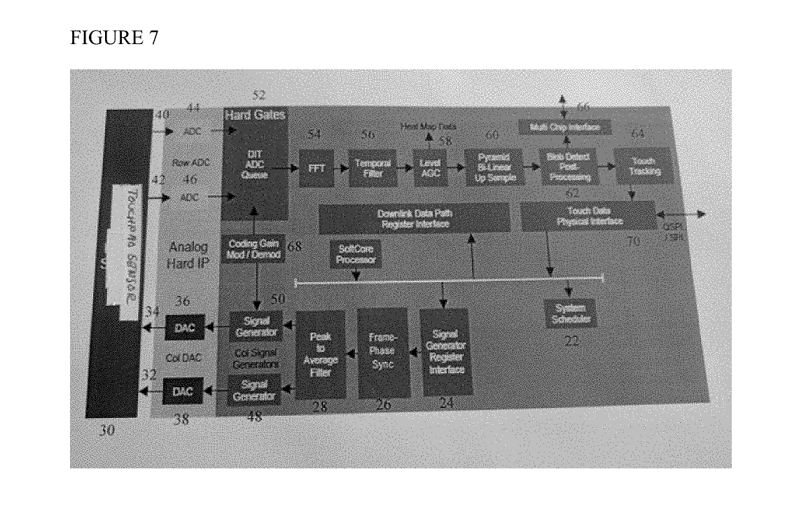

FIG. 7 provides a functional block diagram of an illustrative frequency division modulated touchpad detector. A touchpad sensor 30 according to the disclosure is shown; transmitted signals are transmitted to the rows 32, 34 of the touchpad sensor 30 via digital-to-analog converters (DAC) 36, 38 and time domain received signals are sampled from the columns 40, 42 by analog-to-digital converters (ADC) 44, 46. The transmitted signals are time domain signals generated by signal generators 48, 50 which are operatively connected to the DAC 36, 38. A Signal Generator Register Interface block 24 operatively connected to the System Scheduler 22, is responsible for initiating transmission of the time domain signals based on a schedule. Signal Generator Register Interface block 24 communicates with Frame-Phase Sync block 26, which causes Peak to Average Filter block 28 to feed Signal Generator blocks 48, 50 with data necessary to cause the signal generation.

Changes in the received signals are reflective of touch at the touchpad sensor 30, noise and/or other influences. The time domain received signals are queued in hard gates 52, before they are converted into the frequency domain by FFT block 54. A Coding Gain Modulator/Demodulator block provides bidirectional communications between the Signal Generator blocks 48, 50 and hard gates 52. A temporal filter block 56 and level automatic gain control (AGC) block 58 are applied to the FFT block 54 output. The AGC block 58 output is used to prove heat map data and is fed to UpSample block 60. UpSample block 60 interpolates the heat map to produce a larger map in an effort to improve accuracy of Blob Detection block 62. In an embodiment, up sampling can be performed using a bi-linear interpolation. Blob Detection block 62 performs post-processing to differentiate targets of interest. Blob Detection block 62 output is sent to Touch Tracking block 64 to track targets of interest as they appear in consecutive or proximal frames. Blob Detection block 62 output components can also be sent to a multi-chip interface 66 for multi-chip implementations. From the Touch Tracking block 64, results are sent to the Touch Data Physical Interface block 70 for short distance communication via QSPI/SPI.

In an embodiment, there is one DAC per channel. In an embodiment, each DAC has a signal emitter that emits a signal induced by the signal generator. In an embodiment, the signal emitter is driven by analog. In an embodiment, the signal emitter can be a common emitter. In an embodiment, signals are emitted by a signal generator, scheduled by the system scheduler, providing a list of digital values to the DAC. Each time the list of digital values is restarted, the emitted signal has the same initial phase.

In an embodiment, the frequency division modulated touch detector (absent the touchpad sensor) is implemented in a single integrated circuit. In an embodiment, the integrated circuit would have a plurality of ADC inputs and a plurality of DAC outputs. In an embodiment, the integrated circuit would have 36 ADC inputs and 64 orthogonal DAC outputs. In an embodiment, the integrated circuit is designed to cascade with one or more identical integrated circuits, providing additional signal space, such as 128, 192, 256 or more simultaneous orthogonal DAC outputs. In an embodiment, the ADC inputs are capable of determining a value for each of the DAC outputs within the signal space of the orthogonal DAC outputs, and thus, can determine values for DAC outputs from cascaded ICs as well as DAC outputs on the IC where the ADC resides.

The present systems and methods are described above with reference to block diagrams and operational illustrations of methods and devices for provide for designing, manufacturing and using touchpads and touchpad sensors. It is understood that each block of the block diagrams or operational illustrations, and combinations of blocks in the block diagrams or operational illustrations, may be implemented by means of analog or digital hardware and computer program instructions. Computer program instructions may be provided to a processor of a general purpose computer, special purpose computer, ASIC, or other programmable data processing apparatus, such that the instructions, which execute via a processor of a computer or other programmable data processing apparatus, implements the functions/acts specified in the block diagrams or operational block or blocks. Except as expressly limited by the discussion above, in some alternate implementations, the functions/acts noted in the blocks may occur out of the order noted in the operational illustrations. For example, and generally in FIG. 7, the order of execution if blocks shown in succession may in fact be executed concurrently or substantially concurrently or, where practical, any blocks may be executed in a different order with respect to the others, depending upon the functionality/acts involved.

While the invention has been particularly shown and described with reference to a preferred embodiment thereof, it will be understood by those skilled in the art that various changes in form and details may be made therein without departing from the spirit and scope of the invention.

What is claimed is:

1. A touch detector, comprising:
touch surface;
plurality of antennae comprising plurality of row antennae and plurality of column antennae, the plurality of antennae being positioned beneath the touch surface;
each of the plurality antennae being spaced apart from each other of the plurality of antennae such that no portion of any one of the plurality of antennae touches any portion of any other of the plurality of antennae;
the plurality of row antennae being organized into N logical rows such that each of the plurality of row antennae is associated with one of the N logical rows, each of plurality of row antennae within each of the N logical rows being conductively coupled together by a row trace;
the plurality of column antennae being organized into M logical columns such that each of the plurality of column antennae is associated with one of the M logical columns, each of the plurality of column antennae within each of M logical columns being conductively coupled together by a column trace;
N signal emitters, where N is at least two, each of the N signal emitters being conductively coupled to one of the N row traces, the N signal emitters being adapted to simultaneously output N frequency-orthogonal signals, each of the N frequency-orthogonal signals being frequency orthogonal to each of the other N frequency-orthogonal signals;
M signal receivers, where M is at least two, each of the M signal receivers conductively coupled to one of the M column traces, each of the M signal receivers being adapted to capture a frame of signals present on the coupled column trace;
signal processor adapted to:
(i) determine a measurement for each of the frequency-orthogonal signals from each frame, each measurement corresponding to an amount of each of the frequency-orthogonal signals present on the column trace during a time the corresponding frame was received; and
(ii) produce a heat map of touch proximate to the surface, the heat map being based at least in part on the measurements.

2. The detector of claim 1, wherein:
each of the plurality of row antennae being positioned such that at least two of the plurality of column antennae are equidistant therefrom;
each of the plurality of column antennae being positioned such that at least two of the plurality of row antennae are equidistant therefrom;

3. The detector of claim 2, wherein each of the plurality of row antennae are positioned such that four of the plurality of column antennae are equidistant therefrom.

4. The detector of claim 2, wherein each of the plurality of column antennae are positioned such that four of the plurality of row antennae are equidistant therefrom.

5. The detector of claim 1, wherein the plurality of row traces are traces on a first side of a first substrate.

6. The detector of claim 5, wherein the plurality of row antennae are supported by the first side of the first substrate.

7. The detector of claim 5, wherein the plurality of column traces are traces on a second side of the first substrate.

8. The detector of claim 5, wherein the plurality of column traces are traces on a second substrate, and the first substrate and the second substrate are sandwiched together beneath the touch surface.

9. The detector of claim 5, wherein the first substrate is covered by the touch surface.

10. The detector of claim 1, further comprising a base, and wherein the touch surface has a touch side and a bottom side, and the row traces are traces on the bottom side; and wherein the base has an upper side, and the column traces are traces on the upper side.

11. The detector of claim 1, wherein the signal processor is further adapted to identify one or more touch objects based, at least in part, on the heat map.

12. The detector of claim 11, wherein the signal processor is further adapted to track one or more touch objects over time, based, at least in part, on successive heat maps.

13. A touch detector, comprising:
touch surface;
plurality of antennae comprising plurality of row antennae and plurality of column antennae, the plurality of antennae being positioned beneath the touch surface;
each of the plurality antennae being spaced apart from each other of the plurality of antennae such that no portion of any one of the plurality of antennae touches any portion of any other of the plurality of antennae;
N row traces, N being at least two;
the plurality of row antennae being organized into N logical rows such that at least one row antenna is associated with each of the N logical rows, the row antennae associated with each of the N logical rows being conductively coupled to a respective one of the N row traces;
N signal emitters, each of the N signal emitters being conductively coupled to one of the N row traces, the N signal emitters being adapted to simultaneously output N frequency-orthogonal signals, each of the N frequency-orthogonal signals being frequency orthogonal to each of the other N frequency-orthogonal signals;
M column traces, M being at least two;
the plurality of column antennae being organized into M logical columns such that at least one column antenna is associated with each of the M logical columns, the column antennae associated with each of the M logical columns being conductively coupled to a respective one of the M column traces;
M signal receivers, each of the M signal receivers conductively coupled to one of the M column traces, each of the M signal receivers being adapted to capture a frame of signals present on the coupled column trace;
signal processor adapted to produce a heat map of touch proximate to the touch surface, the heat map being based at least in part on a measurement for each of the frequency-orthogonal signals from each frame.

14. The touch detector of claim 13, wherein each one of the row antennae associated with any one of the N logical rows are further apart from each other than from at least one row antennae not associated with that logical row.

15. The touch detector of claim 13, wherein each one of the column antennae associated with any one of the M logical columns are further apart from each other than from at least one column antennae not associated with that logical column.

16. The touch detector of claim 15, wherein each one of the column antennae associated with any one of the M logical columns are further apart from each other than from at least one column antennae not associated with that logical column.

17. The touch detector of claim 13, wherein:
the N row traces are traced on a first substrate, and the plurality of row antennae are supported by the first substrate; and
wherein the M column traces are traced on a second substrate, and the plurality of column antennae are supported by the second substrate.

18. The touch detector of claim 17, wherein the plurality of row antennae are further positioned such that each of the row antennae is oriented at an angle upward from the surface of the substrate of at least 45 degrees.

19. The touch detector of claim 18, wherein the plurality of row antennae are further positioned such that each of the row antennae is oriented at an angle upward from the surface of the substrate at least 60 degrees.

20. The touch detector of claim 19, wherein the plurality of row antennae are further positioned such that each of the row antennae is oriented at a right angle with the surface of the substrate.

21. The touch detector of claim 17, further comprising:
mechanically deformable layer between the first substrate and the second substrate, the mechanically deformable layer urging the first substrate and the second substrate apart to a neutral position, the mechanically deformable layer being deformable in response to touch on the touch detector.

22. The touch detector of claim 21, wherein the mechanically deformable layer is a dielectric.

23. The touch detector of claim 21, wherein the touch surface is deformable in response to touch.

24. The touch detector of claim 23, wherein the touch surface is locally deformable in response to touch.
